(19) United States
(12) Patent Application Publication
(10) Pub. No.: US 2007/0065114 A1
(43) Pub. Date: Mar. 22, 2007

(54) Video camera capable of uninterrupted recording

(76) Inventor: Xin Wen, Palo Alto, CA (US)

Correspondence Address: Wen, Xin, 3449 Rambow Drive, Palo Alto, CA, 94306, US

(21) Appl. No.: 11/229,974

(22) Filed: Sep. 19, 2005

(51) Int. Cl. H04N 5/91

(52) U.S. Cl. 386/107

(57) ABSTRACT

A method for video recording includes converting the first portion of a series of optical signals to a first video data by an image sensor in a video recording device and subsequently converting the second portion of the series of optical signals to a second video data without interruption by the image sensor. The first video data is stored in a first long-term data storage till the first long-term data storage is substantially full. The second video data is stored in a secondary memory. The first long-term data storage is removed from the video recording device. The second video data is copied from the secondary memory to a second long-term data storage.

### TECHNICAL FIELD

This application relates to a video recording device, specifically, to a video camera having replaceable memory devices.

### BACKGROUND

Video photography is a popular way for people to capture and preserve their valued memories. During a scene capturing, the video data are typically recorded on a replaceable storage device such as magnetic tape, DVD-R, CD-R, etc. A drawback of using such replaceable storage devices are that the replaceable storage device can be filled up during the middle of a recording event. For example, a magnetic tape can run out during the recording of ballet performance or a birthday party. Memorable scenes may be missed during the change to a new magnetic tape. Furthermore, a spare magnetic tape may not be handily available at scene of the events.

Another drawback of the current video camera devices is that the data recorded can include a lot of uninteresting video data. The video camera can be left on a recording mode by accident to capture and store random images. An interesting scene may or may not occur after a long period of waiting period. The video data stored on the replaceable storage device are thus not more efficiently used for keeping the memorable scenes.

### SUMMARY

In one aspect, the present invention relates to a method for video recording, comprising:

converting the first portion of a series of optical signals to a first video data by an image sensor in a video recording device;

subsequently converting the second portion of the series of optical signals to a second video data without interruption by the image sensor;

storing the first video data in a first long-term data storage in the video recording device till the first long-term data storage is substantially full;

storing the second video data in a secondary memory in the video recording device;

removing the first long-term data storage from the video recording device;

electrically connecting a second long-term data storage with the image sensor in the video recording device; and

copying the second video data from the secondary memory to the second long-term data storage.

In another aspect, the present invention relates to a method for video recording, comprising:

converting the first portion of a series of optical signals to a first video data by an image sensor in a video recording device;

storing the first video data in a long-term data storage in the video recording device;

converting the second portion of the series of optical signals to a second video data without interruption by the image sensor;

storing the second video data in a secondary memory in the video recording device;

processing the second video data in response to one or more commands of a user of the video processing system to produce an edited version of the second video data; and

storing the edited version of the second video data in the long-term data storage.

In another aspect, the present invention relates to a video recording device, comprising:

an image sensor configured to produce a first video data and a second video data in response to optical signals; and

a recording circuit in data communication with the image sensor, configured to store the first video data in a long-term data storage, the second video data in a secondary memory, and a third video data to the long-term data storage in response to the second video data.

Implementations of the system may include one or more of the following. The long-term data storage can include one or more of a magnetic tape, a recordable disk, a hard drive, a DVD-R, and a CD-R. The secondary memory can include one or more of a RAM, DRAM, static random access memory (SRAM), EEPROM, and a flash memory. The method for video recording can include storing the second video data in the long-term data storage and subsequently copying the second video data from the long-term data storage to the secondary data storage. The method for video recording can further include removing the second video data stored in the long-term data storage or the second video data stored in the secondary memory. The method for video recording can further include partitioning the long-term data storage to a first portion to store the first video and a second portion to store the edited version of the second video data. The method for video recording can further include automatically processing the first video data and the second video data in accordance with one or more predetermined criteria. The method for video recording can further include displaying the first video data or the edited version of the second video data.

Implementations of the system may include one or more of the following. The video recording device can further include an image processor configured to automatically process the first video data and the second video data produced by the image sensor in accordance to one or more predetermined criteria. The video recording device can further include an image processor configured to process the second video data in response to one or more commands of a user to produce an edited version of the second video data. The third video data can be the edited version of the second video data. The video recording device can further include a user interface configured to receive the command from the user to produce the edited version of the second video data. The video recording device can further include an optical system configured to project an image of a scene onto the image sensor to produce the optical signals. The video recording device can further include a recording system configured to store the second video data in the secondary memory and/or to store the first video data in the long-term data storage. The long-term data storage can include one or more of a magnetic tape, a recordable disk, a hard drive, a DVD-R, and a CD-R. The secondary memory can include one or more of a RAM, DRAM, static random access memory (SRAM), EEPROM, and a flash memory. The recording circuit can be configured to store the second video data in the long-term data storage and subsequently copy the second video data from the long-term data storage to the secondary memory. The recording circuit can be configured to partition the long-term data storage to a first portion to store the first video data and a second portion to store the third video data.

An advantage of the present invention is that the disclosed system and methods allow a photographer to continue capturing video images of scenes using a video camera even when the tape or the recordable disk in the video camera is full. The video data is stored in a secondary memory device until a new tape or recordable disk is installed. The temporarily stored video data can be transferred to and stored on the new tape. The photographer can thus capture an event without interruption by the tape change or because of the lack of a spare tape at hand.

Another advantage of the present invention is that the disclosed system and methods allow a photographer of a video camera to preview, edit, and condense captured video data on a video camera. The unwanted video data can be deleted which allows the magnetic tape to be more efficiently used for storing the most memorable scenes.

Yet another advantage of the invention is that the disclosed system and methods allow the photographer to edit the captured video scenes without using a computer or specialized software. It provides the photographer the flexibility where and when to edit the recorded video data.

The details of one or more embodiments are set forth in the accompanying drawing and in the description below. Other features, objects, and advantages of the invention will become apparent from the description and drawings, and from the claims.

### BRIEF DESCRIPTION OF THE DRAWINGS

FIG. 1 is a block diagram of the video recording system.

FIG. 2 illustrates the process for changing the data storage device in the video recording system.

FIG. 3 illustrates a process for editing and managing video data in the video recording system.

FIG. 4 illustrates another process for editing and managing video data in the video recording system.

FIG. 5 illustrates an arrangement for recording captured video data and edited video data.

FIG. 6 illustrates another arrangement for recording captured video data and edited video data.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

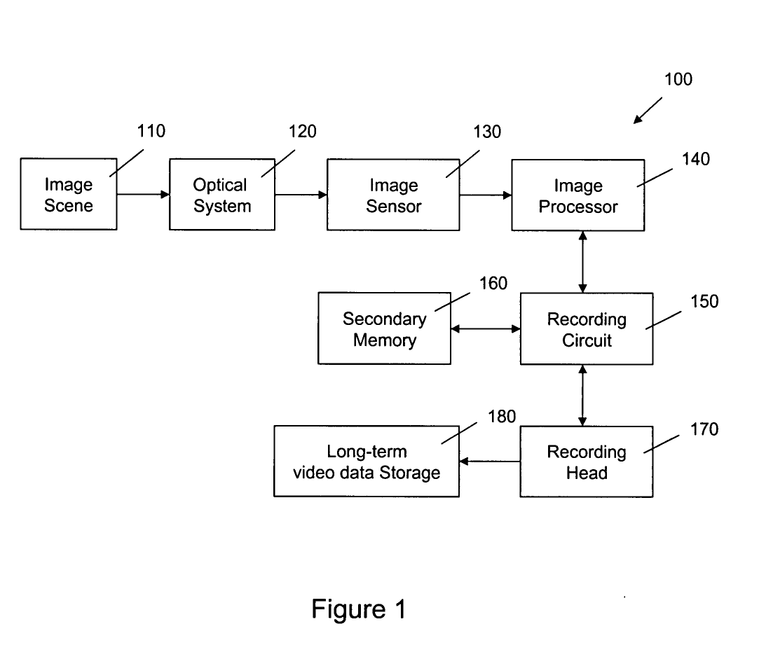

As shown in FIG. 1, the video recording system 100 includes an optical system 120 that can produce the video images of a live image scene 110 on an image sensor 130 such as CCD or CMOS sensors. The image sensor 130 can include different sensors each for a red, green, or blue color, or an image sensor covered by a color filter array that that splits the captured video images into three sets of color video data. The optical signals captured by the image sensor 130 are converted into video signals comprising a series of image frames. The video recording system 100 can also include an Analog-to-Digital converter to signals produced by the image sensor to digital image data. The video images in the video signals can be automatically processed by the image processor 140 for such image processing operations as color plane construction from the color filter array, tone calibration, color calibration, noise compensation, image correction, image compression, and transformation to a specified video standard, etc. The image processing operations can be specified by predetermined criteria set by the manufacturer or by the user of the video recording system 100. The processed video data is transferred from the image processor 140 to the recording circuit 150 that can control the storing of the processed video data in secondary memory device 160 or the recording of the processed video data by the recording head 170 on the long-term video data storage 180. The long-term video data storage 180 can include magnetic tape for digital or analog recording format (e.g. Mini-DV, Digital 8 mm or 8 mm etc.), DVD-R, CD-R, hard drives, etc.

The secondary memory device 160 and the long-term video data storage 180 can be detached and replaced. The video recording system 100 includes a recording system that can include the recording circuit 150 and the recording head 170. The recording system can include mechanisms for receiving and holding the secondary memory device 160 and the long-term video data storage 180, and electric interfaces and circuits such as the recording circuit 150 for writing and retrieving video data to and from the secondary memory device 160 and the long-term video data storage 180. The recording head 170 is compatible with the type of long-term video data storage 180 such as magnetic tape, DVD-R, CD-R, hard drives. For example, the recording head 170 can be a magnetic head for recording over a magnetic tape, a head for writing or retrieving data from hard drive, or a laser head for writing to a DVD-R or a CD-R disk.

The secondary memory device 160 can be a random access memory (RAM), dynamic random access memory (DRAM), static random access memory (SRAM), electrically erasable programmable read-only memory (EEPROM) such as a flash memory, and so on. The secondary memory device 160 can also be a different type or the same type of memory that can store data for long term. For example, the secondary memory can include a mini-hard drive, an auxiliary magnetic tape.

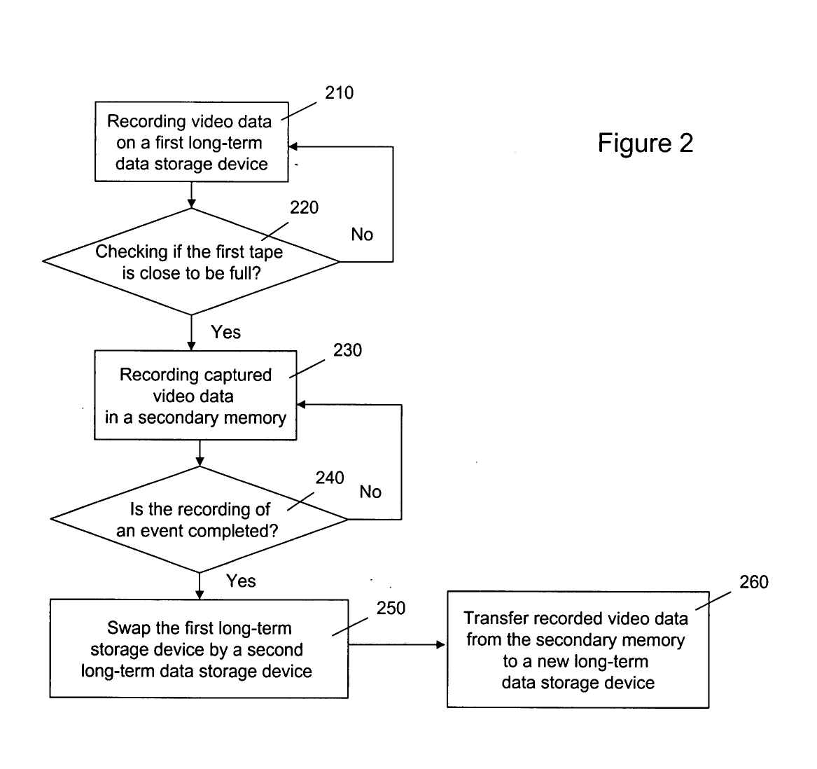

The secondary memory device 160 can be useful in several situations. As shown in FIG. 2, the video recording system 100 starts to capturing video images and recording the video data on the long-term video data storage 180 in step 210. The recording circuit 150 tracks the amount of storage left on the long-term video data storage 180 in step 220. The recording circuit 150 switches to storing the video data in the secondary memory device 160 if the long-term video data storage 180 is almost full in accordance to a predetermined criterion in step 230. For example, the criteria can require the long-term video data storage 180 to be 98% full etc. The switch over from the long-term video data storage 180 to the secondary memory device 160 is activated electronically. The photographer can continuously capture the image scenes without interruption by the change of video tapes or disks. The recording is not affected by the mechanical disturbances of the tape or disk changes.

After the recording of an event is competed in step 240, the substantially full long-term data storage device 180 is removed and replaced by a new long-term video storage device 180 in step 250. The mechanical movement caused by the replacement will not affect the stability of the video recording because the video recording of the event has been completed. The video data can be kept on the secondary memory device by SRAM or EPROM, or RAM supported by the battery power even when the video recording system is powered off. The video data stored on the secondary storage device 160 is subsequently copied to the new long-term video storage device 180 in step 260. The video data on the secondary storage device 160 can then be removed for future storage usages. The new long-term video storage device 180 can be used to store video data for the next event.

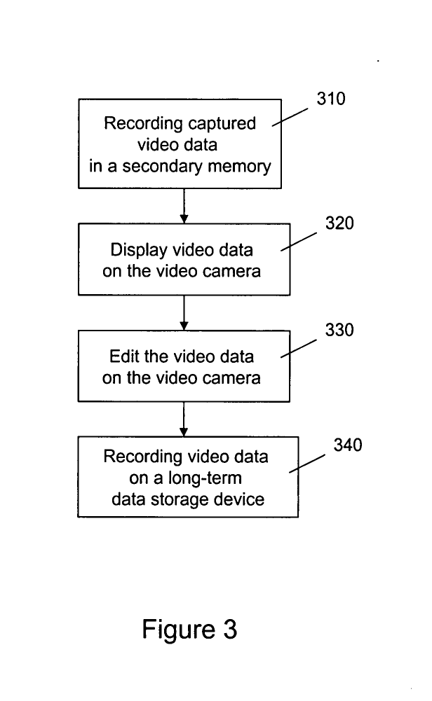

FIG. 3 illustrates a process for editing and managing video data in the video recording system 100. The captured and processed video data is stored in the secondary memory device 160 in step 310. The video data can be displayed or played on the display on the video recording system 100 in step 320. The photographer can edit the video clips using functions provided on the video recording devices. The functions can for example be provided by a touch-screen, buttons, or other types of interactive user interface features. The editing can include cutting, deleting, compiling, splicing, color enhancement, caption, special effects, sound recording, compression using various formats such as MPEG and Digital Video, etc. The video editing can be conducted by the image processor 140 in the video recording system 100. The edited video data can be stored in the long-term video storage device 180 in step 340.

The capability of on-board video editing allows the photographer or other users to edit their videos at times and locations convenient to them. The video editing can also be done with the need for a special equipment or software. Furthermore, the edited video data can be more condense or more compressed, which allow more efficient use of the long-term video storage device 180 in the video recording system 100. After the storing of the edited video data can be stored in the long-term video storage device 180, the photographer or other users can make a decision whether to delete the originally recorded video data from the secondary memory device 160 to move more room for more recording of the processed captured video data.

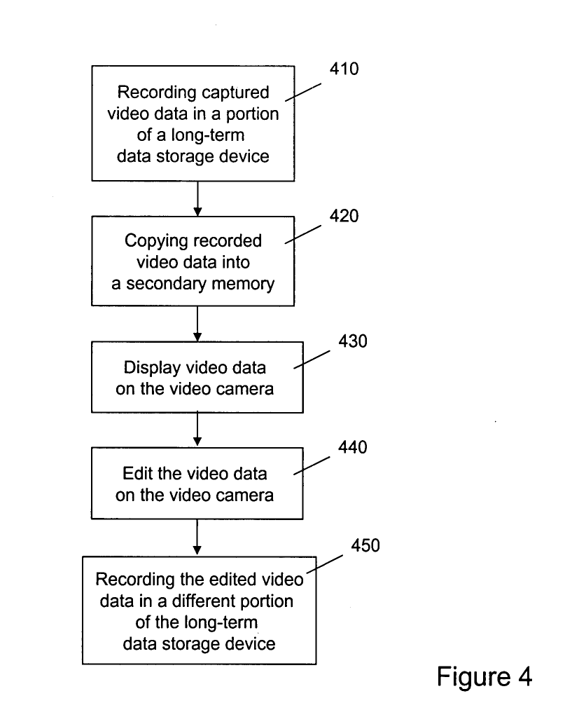

FIG. 4 illustrates another process for editing and managing video data in the video recording system 100. The captured and processed video data is recorded in a portion of the long-term data storage device 180 in step 410. The recorded video data is then copied to the secondary memory device 160 in step 420. The copied video data can be displayed by a display device on board in step 430. The video data can be edited by an interactive user interface on the video recording device 100 in step 440 as described above. The edited video data is finally recorded in another portion of the long-term data storage device 180 in step 450. The long-term data storage device 180 can be partitioned to respectively store processed video data and the edited video data. Alternatively, the storage locations of the processed video data and the edited video data can be dynamically selected on the long-term data storage device 180.

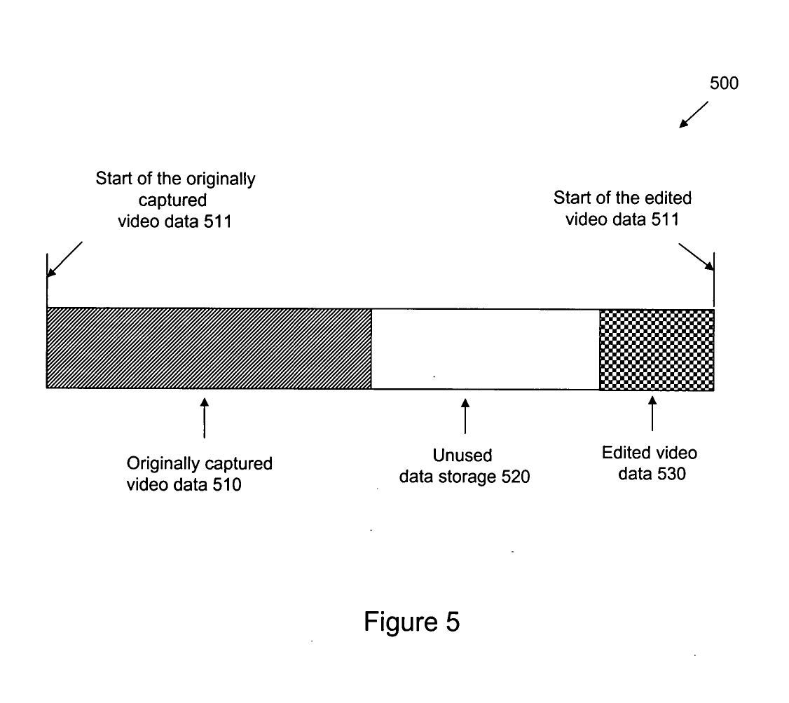

FIG. 5 illustrates an arrangement for recording originally captured video data and edited video data in consistence with FIG. 4. The long-term data storage device 180 includes a physical media that can store video data in a data storage structure 500. The originally captured (and processed) video data 510 is stored at the left end of the data structure 500. The data structure 500 can represent the linear sequence of a storage device such as a video tape or a recordable disk. For example, the originally captured video data can start from one end of a video tape and successfully recorded to the middle of the video tape (or recordable disk). The edited video data 530 can be recorded starting from the opposite end of the video tape (or recordable disk). The originally captured video data 510 and the edited video data 530 is separated by unused data storage 520 that can be used both recording the originally captured video data 510 or the edited video data 530. The photographer can conveniently choose to keep both the originally captured video data 510 and the edited video data 530.

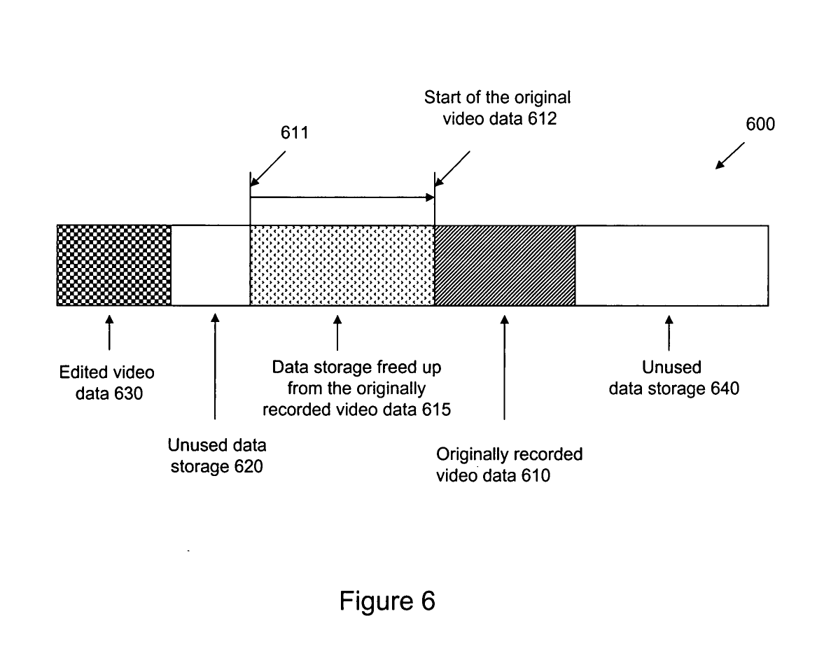

FIG. 6 illustrates another arrangement for recording originally captured video data and edited video data in consistence with FIG. 4. The data structure 600 includes originally recorded video data 610 having unused data storages 620 and 640 on both sides. After the originally captured video data 610 is copied to the secondary memory device 160 and edited by the photographer, the edited video data 630 is stored starting from the end of the data structure 600. As the edited video data 630 is stored on the long-term data storage device 180, the photographer or user can decide to delete the corresponding originally captured data to free up storage space 615 on the long-term data storage device 180. The freed up storage space 615 can be used to stored the edited video data 630 or the captured (and processed) video data 610. The start of the originally captured video data is moved from 611 to 612.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass all such modifications.

1. A method for video recording, comprising:
producing a first video data by an image sensor in a video recording device;
storing the first video data in a first lon-term data storage in the video recording device;
producing a second video data by the image sensor without interruption after the first video data is produced by the image sensor;
storing the second video data in a secondary memory in the video recording device; and
copying the second video data stored in the secondary memory to a second long-term data storage in the video recording device.

2. The method of claim 1, wherein the step of producing the second video data occurs after the first long-term data storage is substantially filled by the storage of the first video data.

3. The method of claim 1, further comprising:
removing the first long-term data storage from the video recording device, and
inserting the second long-term data storage into video recording device such that the second long-term data storage is in electronic communication with the secondary memory.

4. The method of claim 3, wherein the step of copying is conducted after the step of inserting.

5. The method of claim 1, wherein the long-term data storage is selected from the group of a magnetic tape, a recordable disk, a hard drive, a DVD-R, and a CD-R.

6. The method of claim 1, wherein the secondary memory is selected from the group of random access memory (RAM), dynamic random access memory (DRAM), static random access memory (SRAM), EEPROM, and a flash memory.

7. A method for video recording, comprising:
producing a first video data by an image sensor in a video recording device;
storing the first video data in a long-term data storage in the video recording device;
producing a second video data by the image sensor;
storing the second video data in a secondary memory in the video recording device;
processing the second video data to produce an edited second video data; and
storing the edited second video data in the long-term data storage.

8. The method of claim 7, further comprising:
storing the second video data in the long-term data storage; and
copying the second video data from the long-term data storage to the secondary data storage.

9. The method of claim 7, further comprising:
partitioning the long-term data storage to a first portion configured to store the first video and a second portion configured to store the edited version of the second video data.

10. The method of claim 7, wherein the step of processing comprises processing the second video data automatically in accordance with one or more predetermined criteria or processing the second video data in response to one or more external commands.

11. The method of claim 7, further comprising:
displaying video images on the video recording device in response to the second video data or the edited second video data.

12. A video recording device, comprising:
an image sensor configured to produce a first video data and a second video data in response to optical signals; and
a recording system in electronic communication with the image sensor configured to store the first video data in a first long-term data storage, to store the second video data in a secondary memory and to store a third video data in a second long-term data storage in response to the second video data.

13. The video recording device of claim 12, further comprising:
an image processor configured to process the second video data to produce the third video data.

14. The video recording device of claim 12, wherein the second long-term data storage is the first long-term data storage.

15. The video recording device of claim 14, wherein the recording system is configured to partition the first long-term data storage to a first portion configured to store the first video data and a second portion configured to store the third video data.

16. The video recording device of claim 12, wherein the recording system is configured to store the second video data in the first long-term data storage and copy the second video data from the first long-term data storage to the secondary memory.

17. The video recording device of claim 12, further comprising:
a user interface configured to receive the command from a user to process the second video data to produce the third video data.

18. The video recording device of claim 12, further comprising:
an optical system configured to project an image of a scene to the image sensor to produce the optical signals.

19. The video recording device of claim 12, wherein the long-term data storage is selected from the group of a magnetic tape, a recordable disk a hard drive, a DVD-R, and a CD-R, and wherein the secondary memory is selected from the group of random access memory (RAM), dynamic random access memory (DRAM), static random access memory (SRAM), EEPROM, and a flash memory.

20. The video recording device of claim 12, wherein at least one of the first long-term data storage, the second tong-term data storage, and the secondary memory is configured to be inserted into and removed from video recording device, wherein the recording system is configured to conduct data reading and data writing on the one of the first long-term data storage, the second long-term data storage, and the secondary memory that is inserted into the video recording device.
